(19) United States
(12) Patent Application Publication
(10) Pub. No.: US 2005/0064757 A1
(43) Pub. Date: Mar. 24, 2005

(54) Connector with traction relief

(75) Inventors: Hugo Kathan, Kressbronn (DE); Bernd Heinzl, Egmating (DE)

Correspondence Address: CASELLA & HESPOS, 274 MADISON AVENUE, NEW YORK, NY, 10016, US

(73) Assignee: Yamaichi Electronics Deutschland GmbH, Munchen (DE)

(21) Appl. No.: 10/942,573

(22) Filed: Sep. 16, 2004

(30) Foreign Application Priority Data
Sep. 17, 2003 (DE) 103 43 009.1
Feb. 3, 2004 (DE) 10 2004 005266.2

(51) Int. Cl. H01R 13/627

(52) U.S. Cl. 439/357

(57) ABSTRACT

A fixing device (B) is provided for fixing at least one connector element (36) to a mating piece (44). The fixing device (b) has at least one connector element holder (10) which is designed to at least partly hold at least one connector element (36). At least two fixing elements (14) which are fitted to the connector element holder (10). The fixing elements (14) are capable of springing back and are used to fix the connector element holder (10) to the mating piece (44). The fixing elements (14) in each case have at least one engagement section (28) that is oriented away from the connector element holder (10) and is designed to interengage with the mating piece (44) to fix the connector element (36) to the mating piece (44).

### BACKGROUND OF THE INVENTION

1. Field of the Invention

The present invention relates to a fixing device for a connector, a system for fixing at least one connector element to at least one mating piece and also a method for fixing at least one connector element to at least one mating piece.

2. Description of the Related Art

In the conventional way, a connector, such as a conventional RJ45 network connector, is fixed to the matching bush by a holding device, which represents an integral constituent part of the plug, latching into the bush. Such an arrangement is designed substantially, for example, for the use of a network plug for the connection of a computer to a local network. In this case, the plug merely has to withstand forces which arise on account of the inherent weight of the plug and possibly the inherent weight of the normally short cable.

However, since computers or other microelectronic devices are increasingly being used in production facilities, it is necessary for example to produce network connections between machines used industrially, it being necessary for these connections to be designed in such a way that, in particular, undesired pulling or increased vibration or stress on such a connecting cable does not immediately lead to the plug being released from the matching socket and the connection being broken.

It is therefore an object of the invention to specify a fixing device for a connector which, in particular, provides reliable strain relief for a connector in the coupled or connected state.

### SUMMARY OF THE INVENTION

According to the present invention, a fixing device for fixing at least one connector element to a mating piece comprises: at least one connector element holder which is designed to at least partly hold at least one connector element; at least two fixing elements which are fitted to the connector element holder, are capable of springing back and are used to fix the connector element holder to the mating piece, the fixing elements in each case having at least one engagement section, which is oriented away from the connector element holder and is designed to come into engagement with the mating piece in order to fix the connector element to the mating piece.

A connector element can in this case be a conventional connector element, such as a plug or a socket. The connector element is preferably an electrical connector element, for example a data connector element.

The connector element holder is preferably designed such that it at least partly encompasses the at least one connector element. In this case, the geometric shape of the cross section of the connector element holder can correspond substantially to the geometric form of the cross section of the connector element. In other words, if the connector element is substantially rectangular in cross section, for example, then the connector element holder is preferably likewise designed to be substantially rectangular in cross section. In this case, the connector element holder preferably has four side surfaces, which surround the connector element. However, it is also possible for the connector element and the connector element holder to have a different geometric form. The fixing elements are preferably fixed opposite one another to the connector element holder. In particular, the fixing elements are fitted to opposite sides of the connector element holder. However, it is also possible to fit the fixing devices at another point of the fixing device.

Furthermore, on the connector element holder, there are at least two fixing elements which are capable of springing back, which are used to fix the connector element holder to the mating piece. In this case, the connection to the mating piece can be made mechanically, for example by screws which connect the fixing elements to the mating piece. In particular, the fixing elements can be fixed to the mating piece with the aid of the engagement sections. In this case, the engagement sections belonging to the connector element holder are fitted to the preferably opposite fixing devices at an angle preferably between 70° and 110°, particularly preferably between 85° and 95°, with respect to the connector element holder. The engagement sections are designed such that they come into engagement with the mating piece and thus produce a preferably firm connection between the connector element holder and the mating piece. In this case, coming into engagement preferably means that the engagement sections at least partly overlap walls of the mating piece. The connection can be, for example, a hook and eye system, or the engagement sections can also have adhesive means in order to produce the connection to the mating piece.

The mating piece can have a plate-like form with at least one opening, the engagement sections for example coming into engagement with the edges of the at least one opening and the engagement sections being formed substantially parallel to the plate-like mating piece. Preferably, however, a number of openings can also be made in the mating piece, said number corresponding to the number of engagement sections or being larger. Furthermore, the mating piece can for example also be composed of a further connector element or contain a second connector element, which preferably fits together with the aforementioned connector element. The two connector elements can be, for example, a plug and socket pair.

The invention permits fixing of the connector element by means of a separate fixing device and not, as in the prior art, directly to the matching mating piece by means of a locking device belonging to the connector element and formed in one piece with the connector element. This separate fixing device is preferably formed more stably than a conventional locking device, which must be accommodated at least partly in the second connector element and, accordingly, is small. Because of the more stable design of the fixing device, the connection between the connector element and the mating piece can withstand greater forces than connector elements fixed in a conventional way. As a result, a secure connection between the connector element and the mating piece is ensured, above all in industrial use. A secure connection between the connector element and the mating piece is therefore possible even if an increased tensile force is applied to the connector element.

In a preferred embodiment, the engagement sections in each case run substantially at right angles to a coupling direction of the connector element with the mating piece. The coupling direction according to the present invention is preferably a direction substantially parallel to the direction in which the fixing device with the connector element contained therein is moved in order to be brought into engagement with the mating piece. In particular, the coupling direction is at right angles to the alignment of the engagement sections. The coupling direction can preferably substantially coincide with a direction in which a cable emerges from the connector element, for example a network plug. In other words, the coupling direction is preferably parallel to a longitudinal axial direction of the connector or substantially parallel to the side surfaces of the connector element holder.

As a result, it is ensured that the fixing device can even withstand the action of a considerable tensile force in the axial direction of the cable, that is to say in the direction in which the cable preferably runs out of the connector element and out of the connector element holder, since a coupling surface between the connector element holder and the mating piece is kept as large as possible. Thus, the preferred fixing device according to the invention is able to withstand a greater force in the axial direction than a connector element which is fixed in a conventional way.

In a further preferred embodiment, the fixing elements are designed in such a way that, during the coupling procedure of the fixing device to the mating piece, they are deflected outward, so that the engagement sections come into engagement with the mating piece. The distance of the engagement sections from one another is preferably reduced, that is to say the engagement sections are moved toward each other and toward the connector element holder, in particular to such an extent that the engagement sections for example can be guided through the opening(s) in the mating piece. The fixing elements are preferably designed such that they are capable of springing back and move in the direction toward their original position as soon as there is no longer any force acting on them. In particular, as soon as there is no longer any force acting in the direction of the connector element holder, for example, the fixing elements move in a direction away from the connector element holder again, by which means the engagement sections are preferably brought into engagement with the mating piece.

According to the invention, it is therefore possible, for example, for the coupling surface between the fixing elements in the mating piece to be designed to be as large as possible, since the fixing elements and therefore also the engagement sections fitted thereto are in each case moved in the direction of the connector element holder during the coupling procedure, that is to say the fixing elements and therefore also the engagement sections fitted thereto move in the direction toward one another and can therefore fit into the opening in the mating piece.

In a particularly preferred embodiment of the present invention, guide surfaces in each case inclined with respect to the coupling direction are formed on the fixing elements in such a way that the fixing elements are deflected outward in the direction of the connector element holder as the fixing device is coupled to the mating piece. Guide surfaces is understood in particular to mean surfaces on the fixing elements which are fitted in such a way that they substantially produce contact between the mating piece and the fixing elements and, at the same time, are aligned such that the fixing elements are deflected outward during movement of the fixing device in the coupling direction. In particular, in this case, the fixing elements are deflected outward in such a way that the engagement sections can come into engagement with the mating piece without any further force having to be exerted on the fixing device from the outside, apart from the force in the coupling direction. In other words, automatic fixing of the fixing device to the mating piece, in particular automatic interengagement of the engagement sections with the mating piece, can be achieved.

This embodiment has the advantage that the fixing elements no longer have to be deflected outward in the direction of the connector element holder, for example by being pressed with the fingers; instead it is sufficient to bring the inclined guide surfaces in contact with the mating piece, preferably with opposite edges of an opening in the mating piece, and then to press the fixing device in the coupling direction, that is to say in the direction toward the mating piece. As a result, the fixing elements are preferably deflected outward in the direction of the connector element holder until the engagement sections fit through the opening in the mating piece. Preferably, on account of the ability of the fixing elements to spring back, the fixing elements move in a direction away from the connector element holder again after the engagement sections have at least partly passed through the mating piece, the engagement sections coming into engagement with the mating piece, particularly preferably with the edges of the opening of the mating piece. This ensures that the connector element holder is locked securely to the mating piece, preferably in a direction counter to the insertion direction.

In a further embodiment of the invention, a tie bar is fitted to each of the fixing elements. A tie bar according to the present invention is in particular an element, preferably an integral element of the fixing device, with special mechanical features, such as increased rigidity, preferably in a direction substantially parallel to the coupling direction. The tie bar can in this case substantially have a box-like or cylindrical form and is preferably a connection between the connector element holder and the fixing device. This means that the rigidity in the fixing device is increased with little expenditure on material. Furthermore, the configuration of such a tie bar even permits forces which do not act on the connector element holder in the coupling direction if, for example, the cable does not emerge from the connector element holder in the covering direction to be preferably deflected in such a way that these forces act in the direction of the fixing device. In particular, the fixing device of the present invention can even effectively absorb forces or withstand forces which act on the fixing device at an angle, in particular at right angles to the coupling device. If, for example, the cable emerges from the connector element holder in a direction other than the coupling direction, the fixing device can even withstand tensile forces in the direction of the cable axis.

In a further particularly preferred embodiment of the present invention, the connector element holder and the fixing elements are produced integrally, which means that particularly simple production of the fixing devices is ensured. Furthermore, as a result, the connector element holder can be fitted as simply as possible to a customary connector element, such as a conventional RJ45 network connector.

The invention will be described by way of example in the following text using the accompanying drawings of preferred embodiments.

### BRIEF DESCRIPTION OF THE DRAWINGS

FIG. 1 shows a perspective view of a fixing device according to a preferred embodiment of the present invention.

FIG. 2 shows a perspective view of the fixing device from FIG. 1 with a connector element accommodated therein.

FIG. 3 shows a front view of the fixing device according to FIG. 1 with the connector element accommodated therein.

FIG. 4 shows a rear view of the fixing device according to FIG. 1 with the connector element accommodated therein.

FIG. 5 shows a plan view of the fixing device according to FIG. 1.

FIG. 6a shows a sectional view along the line 6a-6a of FIG. 5 of the fixing device according to FIG. 1.

FIG. 6b shows a side view of the fixing device according to FIG. 1.

FIG. 7 shows a plan view of the fixing device according to FIG. 1 with the connector element accommodated therein.

FIG. 8a shows a sectional view along the line 8a-8a of FIG. 7 of the fixing device according to FIG. 1 with the connector element accommodated therein.

FIG. 8b shows a side view of the fixing device according to FIG. 1 with the connector element accommodated therein.

FIG. 9 shows a plan view of the fixing device according to FIG. 1 with the connector element accommodated therein and a socket having a mating piece fitted thereto.

FIG. 10a shows a sectional view along the line 10a-10a of FIG. 9 of the fixing device according to FIG. 1 with the connector element accommodated therein and a mating piece filled to a socket.

FIG. 10b shows a side view of the fixing device according to FIG. 1 with the connector element accommodated therein and a mating piece fitted to a socket.

FIG. 11 shows a rear view of the fixing device according to FIG. 1 with the connector element accommodated therein, which is fitted to a component, and a front view of a socket with a mating piece fitted thereto.

FIG. 12 shows a perspective view of a conventional connector element.

### DETAILED DESCRIPTION OF THE PREFERRED EMBODIMENT

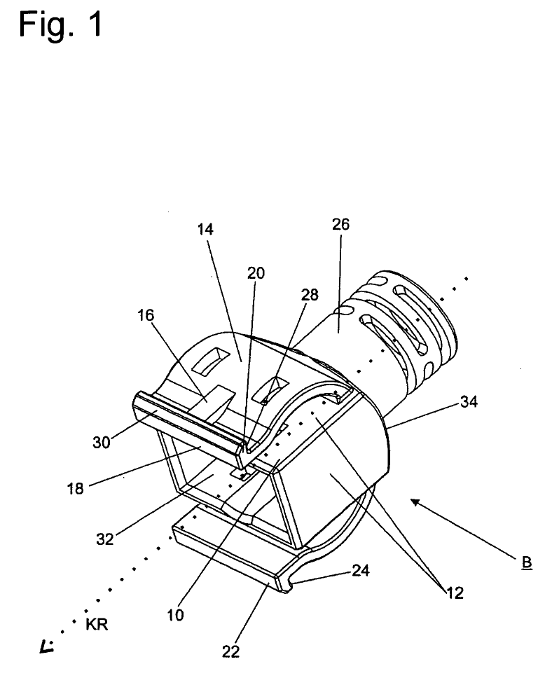

A particularly preferred embodiment of the invention will be described by using FIGS. 1 to 11.

FIG. 1 shows a preferred fixing device B of the present invention in a perspective view. A connector element holder 10 of rectangular cross section, which is surrounded by side surfaces 12, is shown. In each case a fixing element 14 is fitted to two opposite side surfaces 12, each fixing element 14 having a tie rod 16 which extends substantially parallel to a coupling direction KR. Furthermore, a free end 18 of each fixing element 14 is provided with a protrusion 20, the protrusion 20 running substantially at right angles to the coupling direction KR and having a front side and a rear side 22, 24, the rear side 24 being that side which is oriented toward a cable holder 26. The rear side 24 simultaneously forms an engagement section 28, which comes into engagement when the fixing device B is fixed to a mating piece (not illustrated). Furthermore, the front side 22 of the protrusion 20 has an inclined guide surface 30, which is designed in such a way that the protrusion 20 is tapered outward, that is to say in a direction away from the connector element holder 10. The cable holder 26 is fitted substantially to a side of the connector element holder 10 which is opposite an opening 32 in the connector element holder 10, that is to say substantially to a rear side 34 of the connector element holder 10. The cable holder 26 runs substantially parallel to the coupling direction KR.

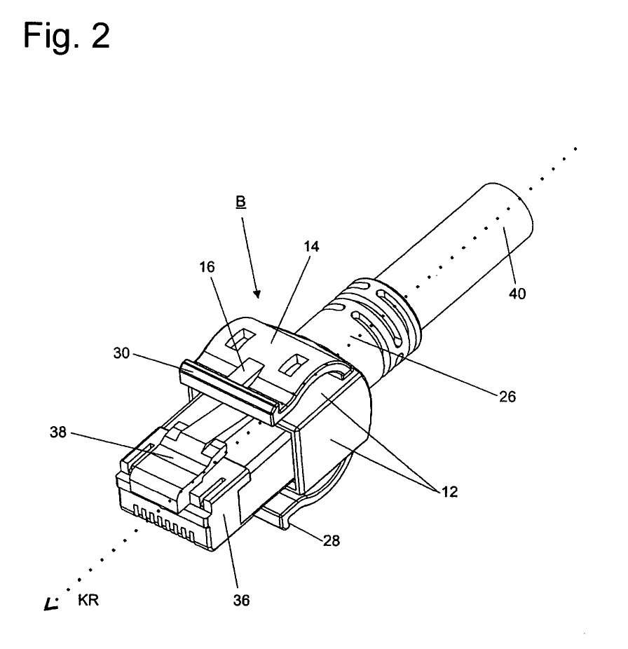

FIG. 2 shows the fixing device B from FIG. 1, a connector element 36 being at least partly encompassed by the side surfaces 12 of the connector element holder 10. In this case, the connector element 36 projects out of the connector element holder 10 through the opening 32 in the coupling direction KR. A conventional locking device 38 fitted to the connector element 36 is in this case kept by the fixing device B, in particular by the connector element holder 10 or one of the side surfaces 12 of the connector element holder 10, in a state in which the locking device 38 cannot be locked. Furthermore, a cable 40 is led through the rear side 24 of the connector element holder 10 and through the cable holder 26.

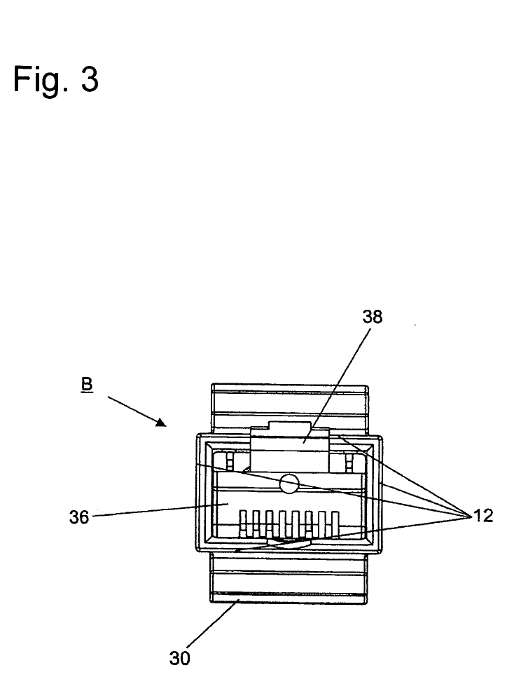

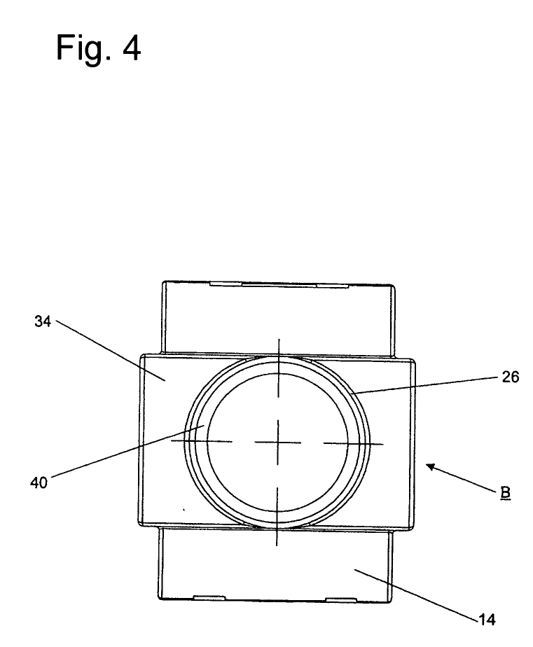

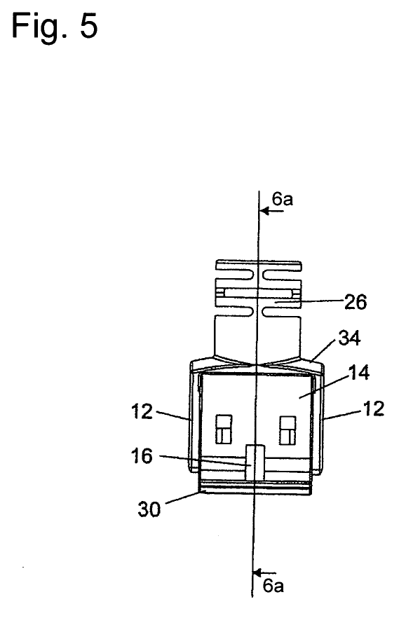

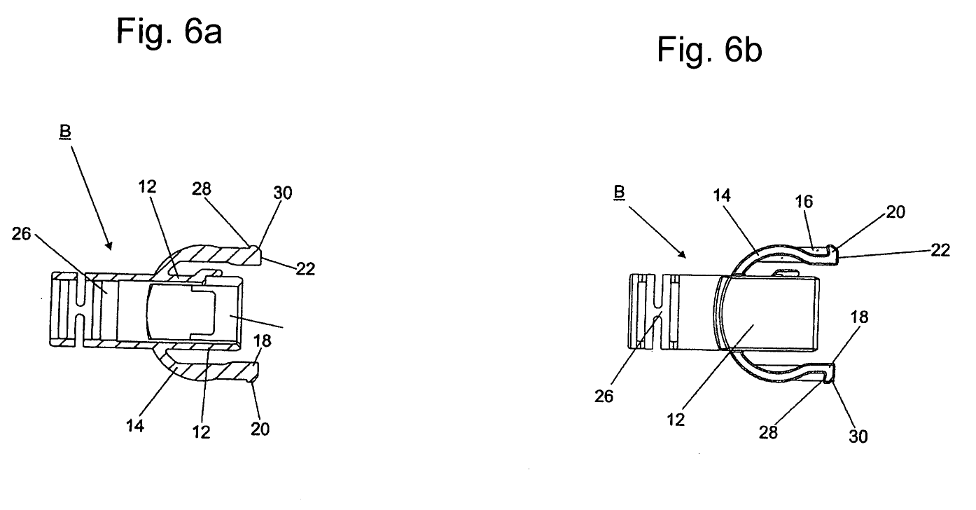

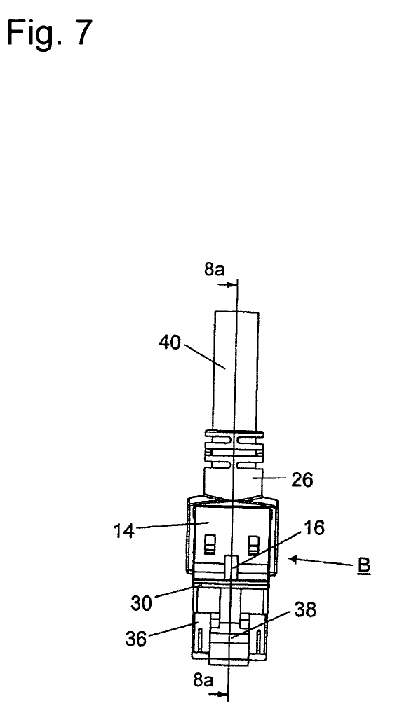

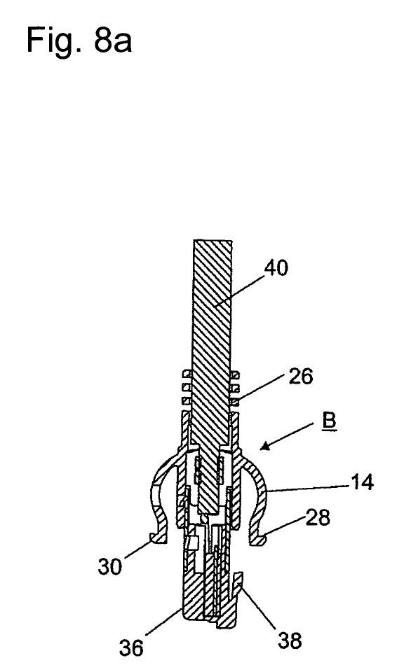

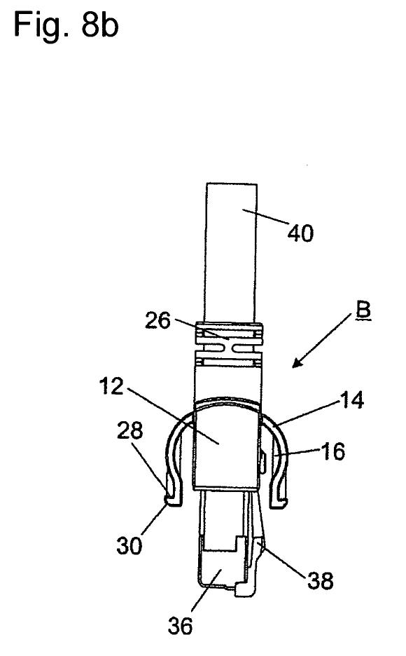

FIG. 3 shows a front view of the fixing device B from FIG. 1 with a connector element 36 held in the connector element holder 10. FIG. 4 shows a rear view of the fixing device B form FIG. 1 with the cable 40, which projects through the rear side 24 of the connector element holder 10 and through the cable holder 26. FIG. 5 shows a plan view of the fixing device B from FIG. 1. The line A identifies a vertical sectional plane of the sectional view of FIG. 6a. FIG. 6a shows a sectional view of the fixing device B from FIG. 1, FIG. 6b shows a side view thereof, it becoming clear from FIG. 6a that the fixing device B is produced integrally and preferably in one piece. FIG. 7 shows a plan view of the fixing device B from FIG. 1. Also depicted are the connector element 36 and the cable 40, as illustrated in FIG. 2. The line A identifies a vertical sectional plane of the sectional view of FIG. 8a. FIG. 8b shows a side view of the fixing device with connector element 36 and cable 40 contained therein.

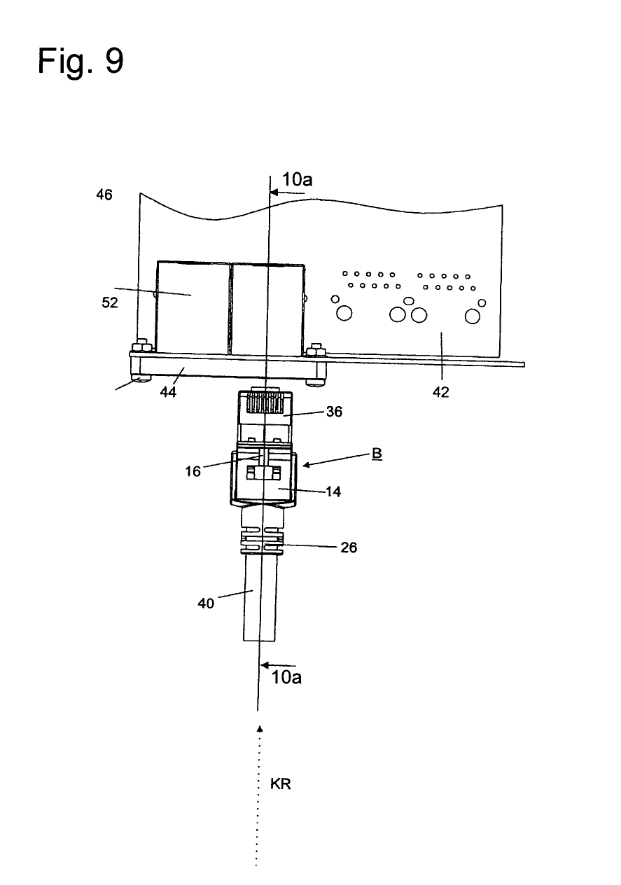

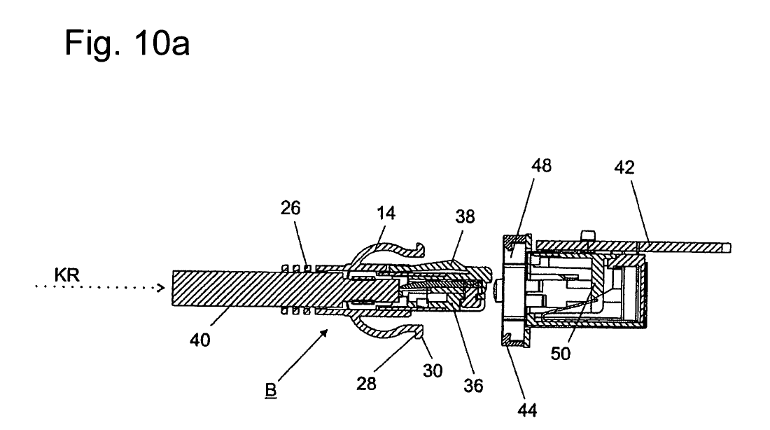

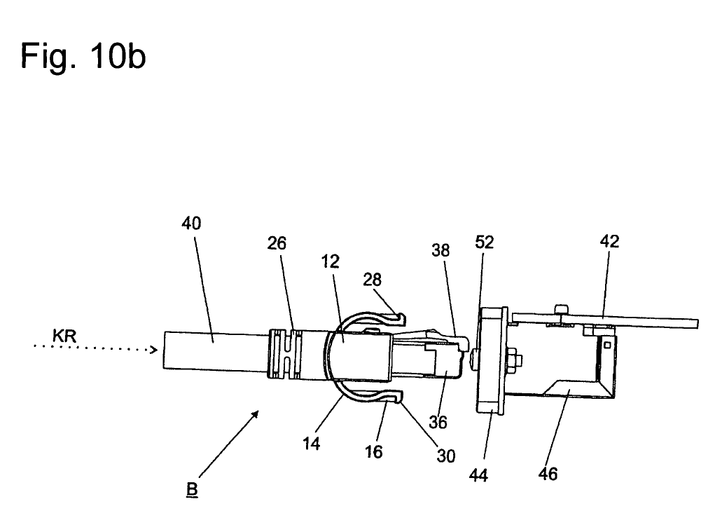

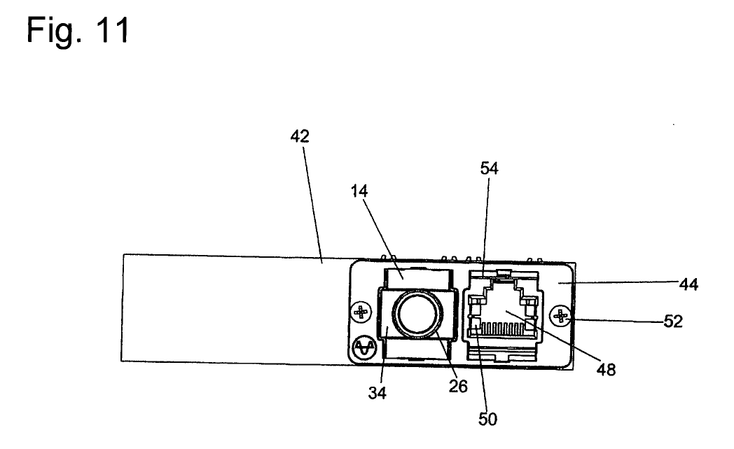

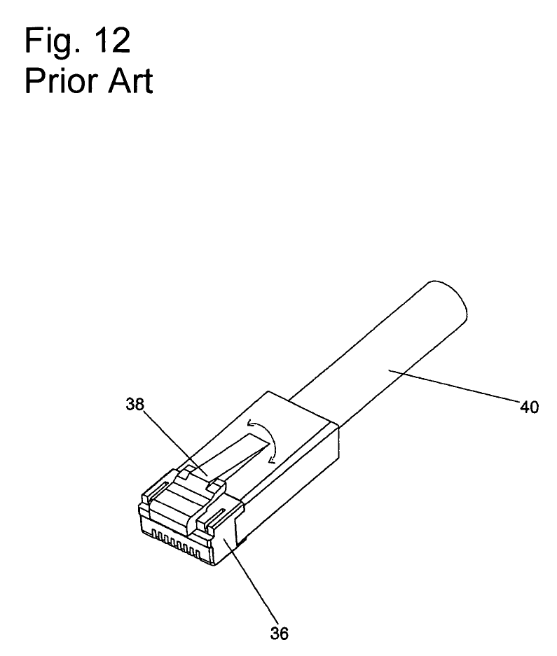

FIG. 9 is a plan view of the fixing device of FIG. 1 with connector element 36 contained in the connector element holder 10. Also illustrated is a component 42, having a mating piece 44 fitted thereto, to which the fixing device B can be fixed. In addition, in the component 42, socket holders 46 for accommodating sockets (not illustrated) are fitted behind the mating piece 44 in the coupling direction KR. The line A identifies a vertical sectional plane of the sectional view of FIG. 10a. FIG. 10a is a sectional view of the device shown in FIG. 9 with the fixing device B according to FIG. 1, with the connector element 36 encompassed by the connector element holder 10, with the mating piece 44 fitted to the component 42 and with the socket holder 46; FIG. 10b is a side view thereof. Also shown in FIG. 10b is a socket 48, which is located in the socket holder 46. FIG. 11 shows a rear view of the fixing device B from FIG. 1, which is fixed to the mating piece 44, the mating piece 44 being fitted to the component 42. Located laterally beside the fixing device is a further opening 48 in the mating piece, through which a further socket 50 is accessible. Thus, a further fixing device B with a further connector element 36 could be fixed to the mating piece 44. In combination with FIGS. 9, 10a and 10b, it can be seen that the mating piece 44 is shaped like a frame and is fixed to the component 42 with the aid of the screw devices 52.

The opening 48 also preferably has edges 54, with which the entry sections 28 of a further fixing device B can come into engagement from the inside. From the inside substantially means that the engagement sections 28 are located between the edges 54 and, for example, are moved in a direction at right angles to the coupling direction KR by means of the fixing elements 14 that are capable of springing back.

When the connector element 36 is inserted into the connector element holder 10, the locking device 38 of the connector element 36 is preferably held by the connector element holder 10 in a state which prevents the locking device 38 locking or coming into engagement with the socket 48. This means that, during the coupling procedure, the engagement sections 28 fitted to the fixing elements 14 preferably come into engagement with the mating piece 44 and hold and lock the fixing device B. Advantageously, in order to couple the fixing device B to the mating piece 44, it is only necessary for the fixing elements 14 to be moved toward each other, which can be achieved by means of pressing, for example between thumb and index finger of a user. For the purpose of uncoupling, it is correspondingly necessary only for the fixing elements 14 to be moved toward each other and for the fixing device B to be pulled in a direction away from the mating piece 44, that is to say counter to the coupling direction KR. Since the fixing device B and the fixing elements 14 fitted thereto are preferably larger than a conventional locking device 38, the fixing device B can also be operated more easily, for example the fixing device B can even be coupled to the mating piece 44 and uncoupled therefrom with gloves.

The aforementioned mating piece 44 is preferably a frame which, for example on the socket 48 fitting together with the connector 36, is particularly preferably fitted to the appropriate component 42 for holding the socket 48. However, the frame can also preferably be an integral constituent part of the socket 48 or of the component 42.

In a further preferred embodiment, the cable holder 26, which encompasses the cable 40 emerging from the connector element 36, is also arranged on the fixing element B. The cable holder 26 is preferably arranged on the rear side 34 of the connector holder 10 or the fixing device B. Particularly preferably, the cable holder 26 is an integral constituent part of the connector element holder 10 or of the fixing device B. The cable holder 26 can also be formed in a direction other then parallel to the coupling direction KR, depending on how the cable 40 is arranged on the connector element 36.

In a further preferred embodiment of the invention, the fixing elements 14 are fitted to the outside on opposite side surfaces 12 of the fixing device B. In another preferred embodiment of the present invention, the engagement sections 28 encompass the mating piece 44.

The connector element holder 10 and/or the fixing elements 14 and/or the cable holder 26 and/or the tie rod 16 are also preferably formed integrally or in one piece, which makes a simple design possible.

The cable holder 26 further preferably prevents the fixing device B, when it is not in engagement with the mating piece 44, being detached from the connector element 36 and moving away from the connector element 36 along the cable 40. In other words, the cable holder 26 fixes the fixing device B substantially to the connector element 36 when the fixing device B is not brought into engagement with the mating piece 44.

In a further preferred embodiment of the fixing device B of the present invention, two fixing elements 14 preferably engage with the mating piece 44, which means that the retaining force and strain relief is increased as compared with a conventional plug, in particular an RJ45 network plug of the prior art.

The fact that the fixing elements 14 are preferably fitted to opposite side surfaces 12 of the connector element holder 10 also advantageously means that the fixing device B is self-centered or aligned during the coupling procedure.

The arrangement of the present invention is advantageously space-saving on account of the locking from the inside, and the forces are transmitted better teethe fixing device B.

Advantageously, as a result of the small space required by the fixing device B, lining up a large number of connector elements 36 in a row in a direction preferably at right angles to the coupling direction KR is possible, it being possible for good handling still to be ensured even in the event of a very restricted access.

The locking also advantageously takes place automatically since, because of the inclined guide surfaces 30, the fixing elements 14 and thus also the engagement sections 28 are deflected outward toward the connector element holder 10 and, on account of the stress built up as a result, move into a locked state in the end position. In other words, locking can preferably be brought about by the fixing device B being placed on the mating piece 44 and then moved in the coupling direction KR without the fixing elements 14 having to be moved toward each other, for example by thumb and index finger.

In a further preferred embodiment, by means of the tie rods 16 respectively fitted to the fixing elements 14 and/or to the engagement sections 28, deformation of the respective fixing elements 14 under tension is advantageously reduced.

In a further preferred embodiment, the mating piece 44 is a frame having 1, 2, 4 or 8 openings as mating piece(s) for 1, 2, 4 or 8 fixing devices B. The mating piece 44 is also preferably formed as an opening in the component 42 with a socket 48 accommodated therein.

Furthermore, it is possible for the fixing device B to be designed to be folded, it preferably being possible for one part, particularly preferably for one half of the fixing device B, to be folded about an axis in a side surface of the fixing device B, so that the fixing device B can also encompass a connector element 36 with cable 40 connected thereto without the cable 40 having to be led through the rear side 34 of the fixing element B.

It is obvious that the connector element can be any desired conventional plug, such as a conventional RJ45 network plug, a conventional USB plug or a conventional FireWire plug or any other conventional plug. Furthermore, the mating piece can be a socket which matches a corresponding plug.

1. A fixing device (B) for fixing at least one connector element (36) to a mating piece (44), comprising:
at least one connector element holder (10) which is designed to at least partly hold at least one connector element (36);
at least two fixing elements (14) which are fitted to the connector element holder (10), are capable of springing back and are used to fix the connector element holder (10) to the mating piece (44), the fixing elements (14) in each case having at least one engagement section (28), which is oriented away from the connector element holder (10) and is designed to interengage with the mating piece (44) in order to fix the connector element (36) to the mating piece (44).

2. The fixing device (B) of claim 1, wherein the engagement sections (28) in each case run substantially at right angles to a coupling direction (KR) of the connector element (36) to the mating piece (44).

3. The fixing device (B) of claim 2, wherein the fixing elements (28) are designed in such a way that, during the coupling procedure of the fixing device (B) to the mating piece (44), they are deflected outward, so that the engagement sections (28) come into engagement with the mating piece (44).

4. The fixing device (B) of claim 3, wherein the fixing elements (14) are deflected in the direction of the connector element holder (10), so that the engagement sections (28) come into engagement with the mating piece (44) from the inside.

5. The fixing device (B) of claim 1, wherein guide surfaces (30) in each case inclined with respect to the coupling direction (KR) are formed on the fixing elements (14) in such a way that the fixing elements (14) are deflected outward as the fixing device (B) is coupled to the mating piece (44).

6. The fixing device (B) of claim 5, wherein the fixing elements (14) are deflected outward in the direction of the connector element holder (10) as the fixing device (B) is coupled to the mating piece (44).

7. The fixing device (B) of claim 1, wherein a tie rod (16) is fitted to each of the fixing elements (14).

8. The fixing device (B) of claim 1, wherein the connector element holder (10) and the fixing elements (14) are produced integrally.
